(19) United States
(12) Patent Application Publication
(10) Pub. No.: US 2026/0120421 A1
(43) Pub. Date: Apr. 30, 2026

(54) AI-ASSISTED DESIGN OF SPACES AND TRANSIENT ATMOSPHERES

(71) Applicant: AUTODESK, INC., San Francisco, CA (US)

(72) Inventors: Bon Adriel ASENIERO, Toronto (CA); Tongyu ZHOU, Providence, RI (US); Frederik BRUDY, Toronto (CA); George William FITZMAURICE, Toronto (CA)

(21) Appl. No.: 19/228,663

(22) Filed: Jun. 4, 2025

Related U.S. Application Data
(60) Provisional application No. 63/713,549, filed on Oct. 29, 2024.

(51) Int. Cl. G06T 19/20; G06F 40/40; G06T 17/00

(52) U.S. Cl. CPC G06T 19/20; G06F 40/40; G06T 17/00; G06T 2200/24; G06T 2210/04; G06T 2219/2012

(57) ABSTRACT

A computer-implemented method for generating three-dimensional (3D) models of environments includes receiving an input; generating, based on the input and using at least one generative artificial intelligence (AI) model, one or more transient primitives for a three-dimensional (3D) model of an environment; applying the one or more transient primitives to the 3D model of the environment to generate a modified 3D model of the environment; and displaying the modified 3D model of the environment via at least one user interface.

### CROSS-REFERENCE TO RELATED APPLICATIONS

This application claims priority benefit of the United States Provisional Patent Application titled, “TECHNIQUES FOR IMPLEMENTING AI-ASSISTED DESIGN OF SPACES AND TRANSIENT ATMOSPHERES,” filed on Oct. 29, 2024 and having Ser. No. 63/713,549. The subject matter of this related application is hereby incorporated herein by reference.

### BACKGROUND

### Field of the Various Embodiments

The various embodiments relate generally to computer science and complex software applications, and, more specifically, to artificial intelligence (AI) assisted design of spaces and transient atmospheres.

### Description of the Related Art

Architectural design involves the planning and creation of structures, where both functionality and aesthetics hold significant importance. Ideally, the architectural design process aims to meet objective requirements related to function and safety while satisfying subjective needs for an aesthetically pleasing environment. Consequently, architectural design emerges as a discipline that encompasses both technical and creative design elements to generate buildings or structures that are safe, durable, attractive, and useful.

To assist in architectural design, a range of architectural design software tools has been developed to support tasks such as digital drafting, three-dimensional modeling, and basic visualization. Such tools typically enable designers to represent structures within a virtual environment and assess general design feasibility. In some cases, additional features are provided for cost estimation or environmental impact analysis. However, such tools are primarily configured to aid in manual workflows and rely heavily on the expertise and intuition of the designer throughout the process.

One drawback of conventional architectural design software tools is that such tools generally focus on the lasting physical properties of a designed environment, such as structure and materials, while often overlooking the impact of transient elements that significantly affect human experience. For example, elements such as lighting, time of day, ambient sound, and weather are frequently ignored. This makes it difficult for architects or designers to fully account for these ephemeral and varying influences on the atmosphere of a given environment during the design process. As a result, even a carefully designed structure or environment may unexpectedly exhibit an unwanted atmosphere that is difficult to alter post-construction.

Another drawback is the lack of facilitation for the creative process within traditional architectural design systems. In particular, designers frequently use images as sources of inspiration, yet conventional design software lacks the capability to extract aspects of an image or video that contribute to the mood or atmosphere of an environment. Additionally, creative design often involves a nonlinear process in which earlier concepts may be revisited or combined to generate new ideas. Conventional software tools, though, do not track the moods or atmospheres associated with a given space or the iterative process by which such qualities were developed, and instead merely present or compare finalized design alternatives for a proposed structure or environment.

As the foregoing illustrates, what is needed in the art are more effective techniques for designing transient atmospheres in structures, spaces, or environments.

### SUMMARY

A computer-implemented method for generating three-dimensional (3D) models of environments includes receiving an input; generating, based on the input and using at least one generative artificial intelligence (AI) model, one or more transient primitives for a three-dimensional (3D) model of an environment; applying the one or more transient primitives to the 3D model of the environment to generate a modified 3D model of the environment; and displaying the modified 3D model of the environment via at least one user interface.

At least one technical advantage of the disclosed techniques relative to the prior art is that the disclosed techniques enable a designer to generate pre-construction simulations of various transient atmospheres for a particular structure, space, or environment. An additional advantage includes the ability to extract one or more transient primitives, such as colors, theme-based objects, lighting, weather effects, and ambient sound, from instances of inspirational media to contribute to a desired transient atmosphere. Furthermore, the disclosed techniques enable designers to gain access to a visual record of previously synthesized transient atmospheres, which can be used to facilitate the synthesis of new transient atmospheres. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 conceptually illustrates a transient atmosphere generation system, according to various embodiments.

FIG. 2 conceptually illustrates a view of a designed environment, according to various embodiments.

FIG. 3 is an illustration of a history node graph, according to various embodiments.

FIG. 4 sets forth a flowchart of method steps for the design of transient atmospheres for a designed environment, according to various embodiments.

FIG. 5 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

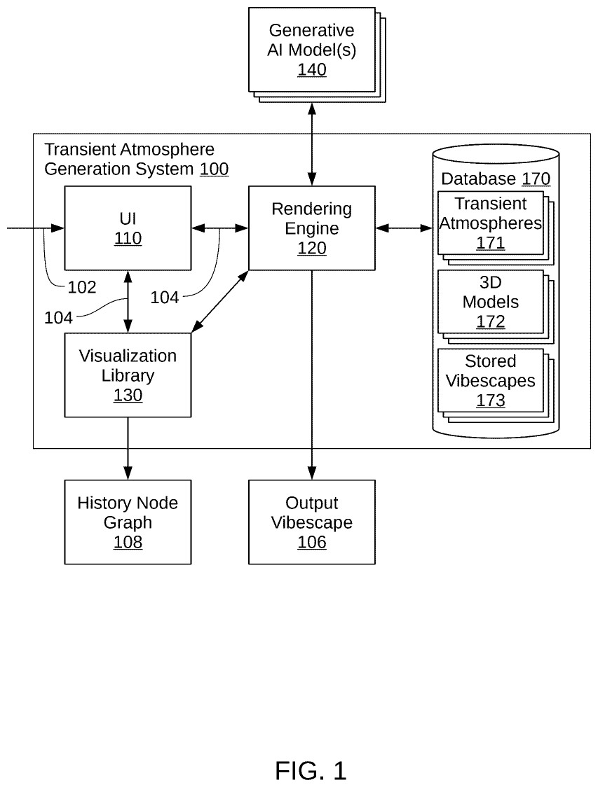

FIG. 1 conceptually illustrates a transient atmosphere generation system 100, according to various embodiments. Transient atmosphere generation system 100 is configured to facilitate generation of a simulated transient atmosphere for a space, structure, or environment, such as a living space or other room in a residence, a building, an entertainment venue or park, an office space, or a business or commercial space. Thus, given a three-dimensional (3D) model of such a space or environment, transient atmosphere generation system 100 enables a designer, architect, or other user to generate a simulation of the transient atmosphere experienced by an occupant of the space or environment under specific conditions, as represented by one or more transient primitives. In the embodiment shown in FIG. 1, transient atmosphere generation system 100 includes a user interface 110, a rendering engine 120, a visualization library 130, and a database 170.

A transient atmosphere, sometimes referred to as an environmental mood or “vibe,” refers to the experience of an occupant of a space or environment in response to the permanent, persistent visual properties of the space or environment, as well as to dynamic elements of the space or environment. Consequently, the transient atmosphere for a fixed structure, room, or environment is based on more than structural elements, such as space geometry and materials, and can be strongly affected by transient elements that provide sensory input to the occupant, such as weather, ambient sound and/or music, time of day, surface colors, the presence of theme-based objects or decorations, lighting effects, temperature, and the like. Thus, by including the effects on an occupant of the transient, whimsical, and/or chance experiential inputs of a space, a transient atmosphere can capture the temporal properties of a space or environment that have a significant impact on the actual lived experience of the space or environment. In light of the above, a transient atmosphere can be considered to be conceptually unique from the architectural design concept of “atmosphere”, which is focused on static architectural elements, such as space geometry and materials.

According to various embodiments, a particular transient atmosphere can be decomposed into various “transient primitives” that are independent from, but can be rendered onto, the physical form and/or structure of an environment or structure. Thus, each transient primitive employed by a designer contributes to the particular transient atmosphere of a space, structure, or environment. Examples of such transient primitives include elements such as time of day, ambient noise, ambient music, objects positioned in the environment, lighting of various portions of the environment, temperature, weather effects on the environment, and color. Taken together, the combination of various transient primitives can be considered a transient atmosphere, which is an experiential construct that is independent from one particular designed environment and can be transferred onto many different designed environments.

User interface (UI) 110 enables a user to provide inputs 102 to and view or otherwise receive outputs 104 from transient atmosphere generation system 100, for example via suitable input/output (I/O) devices. For example, in some embodiments, UI 110 includes a graphical user interface (GUI) that is displayed via a suitable display device. Alternatively, or additionally, in some embodiments, UI 110 includes a command-line interface that enables a user to interact with transient atmosphere generation system 100 via typed commands and text-based output. In some embodiments, the command-line interface can be a terminal window or other text-based window within a GUI. Thus, in some embodiments, inputs 102 and/or outputs 104 can be graphical and/or text-based.

In some embodiments, UI 110 can be implemented as a virtual reality (VR) and/or augmented reality (AR) interface. In such embodiments, UI 110 can include a head-mounted display (not shown) for rendering a VR or AR environment for a user of transient atmosphere generation system 100. In some embodiments, the head-mounted display of UI 110 is employed by a user in conjunction with one or more interaction devices (not shown), which are devices configured to enable a user to interact with portions of the VR or AR environment generated by UI 110. For example, in some embodiments, such interaction devices include a wired glove that is worn by the user. In embodiments in which UI 110 is implemented as a VR and/or AR interface, a designer can be more fully immersed in the transient vibe constructed for a particular space or environment.

Inputs 102 can include a 3D model of a space, structure, or environment for which a designer intends to generate one or more transient atmospheres. Alternatively, or additionally, in some embodiments, inputs 102 include inspirational media from which to construct one or more transient atmospheres, such as images, videos, sound effects, and/or music samples. Alternatively, or additionally, in some embodiments, inputs 102 include one or more slider settings or other value adjustments for adjusting or tuning a weight of a specific transient primitive that is contributing to a transient atmosphere. In such embodiments, a slider setting or value adjustment can indicate a weight of a single transient primitive or indicate an interpolation level between two related transient primitives. For example, a slider input of UI 110 can indicate a relative weighting between two colors, two different times of day, between natural lighting and a particular artificial lighting scheme, and the like.

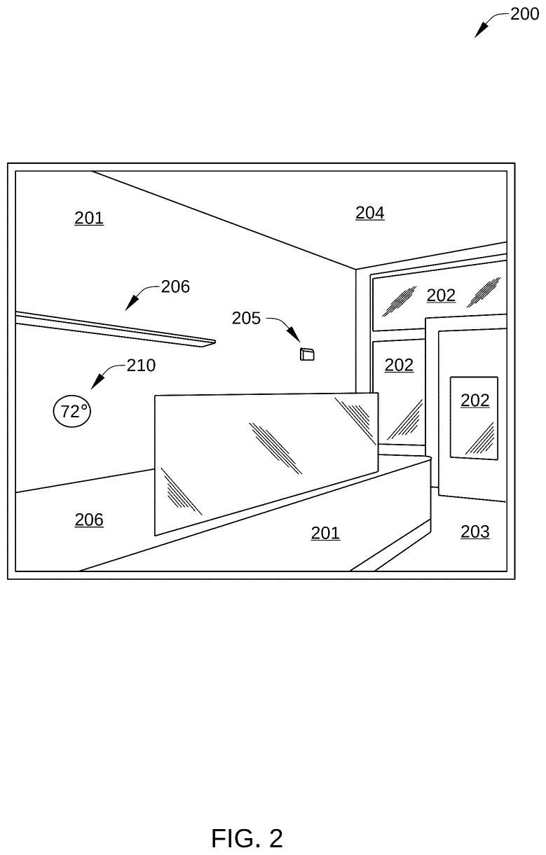

Rendering engine 120 performs 3D rendering of a 3D model of a space, structure, or environment, referred to herein as a “designed environment.” Rendering engine 120 can be implemented as a cloud computing resource and/or as a software program running locally. As noted previously, a designed environment can include any space or environment that can be occupied by a person, such as a living space or other room in a residence, a building, an entertainment venue or park, an office space, or a business or commercial space. Rendering engine 120 generates one or more views of a designed environment of interest, in conjunction with a specified transient atmosphere. Taken together, the designed environment of interest (or a 3D model thereof) and the specified transient atmosphere rendered thereon form a single instantiation of a “vibescape,” which represents a unique user experience associated with the designed environment of interest. According to various embodiments, the transient primitives and associated parameter values that make up the vibescape can be output as an output vibescape 106, stored in database 170 as a stored vibescape 173, and/or provided to UI 110 as an output 104 for display to a user. An example embodiment of a designed environment is described below in conjunction with FIG. 2.

FIG. 2 conceptually illustrates a view of a designed environment 200, according to various embodiments. Designed environment 200 can be any space or environment that can be occupied by a person, such as a living space or other room in a residence, a building, an entertainment venue or park, an office space, or a business or commercial space, among others. In the embodiment illustrated in FIG. 2, a view of designed environment 200 is illustrated that corresponds to a scene or view of designed environment 200 that can be rendered by rendering engine 120 and displayed by UI 110 of transient atmosphere generation system 100 (FIG. 1). Thus, transient atmosphere generation system 100 enables a user to interact with designed environment 200 and an associated transient atmosphere applied thereto via a visual rendering of a 3D scene that includes a portion of designed environment 200. In some embodiments, rendering engine 120 can generate multiple such 3D scenes of a particular designed environment 200 to enable a user to more completely experience the transient atmosphere currently being applied to designed environment 200.

In the embodiment illustrated in FIG. 2, designed environment 200 includes interior surfaces 201, one or more windows 202 that enable natural lighting to enter designed environment 200, a floor 203, a ceiling 204, and one or more interior lighting sources 205. In some embodiments, weather effects and outdoor lighting effects are also visible through windows 202 and can therefore contribute to a particular transient atmosphere applied to designed environment 200. In some embodiments, designed environment 200 can also include one or more exterior surfaces, which are not visible in the current view of designed environment 200. In such embodiments, such exterior surfaces can be altered in appearance by the effect of one or more transient primitives, such as weather effects (e.g., rain, snow, or direct sunlight) outdoor lighting, the addition of certain object (e.g., decorations) and the like.

In operation, transient atmosphere generation system 100 applies the effects of one or more transient primitives to a particular designed environment 200, where each transient primitive is extracted from one or more items of inspirational content. Examples of such transient primitives include, without limitation, time of day, ambient noise, ambient music, decorative objects, artificial lighting, temperature, weather, and color, among others.

For example, in some embodiments, rendering engine 120 can apply the transient primitive “time of day,” which has been extracted from an inspirational image, to designed environment 200. In such an embodiment, brightness and directionality of outdoor lighting entering windows 202 can be determined based on the specific time of day indicated by the transient primitive extracted from inspirational content.

In another example, in some embodiments, rendering engine 200 can apply the transient primitive “ambient noise” to designed environment 200. In such embodiments, the selection of ambient noise applied to designed environment 200 can be extracted from an inspirational video, soundtrack, or other item of inspirational content that includes ambient noise or other sounds. Alternatively, or additionally, in such embodiments, the selection of ambient noise applied to designed environment 200 can be selected by transient atmosphere generation system 100 based on visual content included in an inspirational image or screenshot, such as images of sound sources. When applied to designed environment 200, UI 110 plays back the selection of extracted ambient noise while displaying a 3D rendering of designed environment 200.

In another example, in some embodiments, rendering engine 200 can apply the transient primitive “ambient music” to designed environment 200. In such embodiments, the selection of ambient music applied to designed environment 200 has been extracted from an inspirational video, soundtrack, or other item of inspirational content that includes music, and can be a specific work, selected from a music genre, or a performance by a particular artist. Alternatively, or additionally, in such embodiments, the selection of ambient music applied to designed environment 200 can be selected by transient atmosphere generation system 100 based on visual content included in an inspirational image or screenshot. When applied to designed environment 200, UI 110 plays back the selection of ambient while displaying a 3D rendering of designed environment 200.

In another example, in some embodiments, rendering engine 200 can apply the transient primitive “decorative objects” to designed environment 200. In such embodiments, the decorative objects applied to designed environment 200 can be selected from a database of objects that have been previously associated with certain themes or key words. Alternatively, or additionally, in such embodiments, the decorative objects applied to designed environment 200 can be generated by a suitable generative AI model, based on a text-based descriptor. For example, one of generative AI models 140 in FIG. 1 can be employed by rendering engine 120 to generate such decorative objects. Alternatively, or additionally, in such embodiments, the decorative objects applied to designed environment 200 can be extracted from an inspirational video or image and/or based on visual content included in an inspirational image or screenshot. When applied to designed environment 200, one or more decorative objects are positioned within designed environment 200, for example on shelves 206, mounted on interior surfaces 201, suspended (when appropriate) from ceiling 204, etc. In some embodiments, determination of the locations of the one or more decorative objects can be a rules-based algorithm, where certain categories of objects can be placed on or mounted on other categories of objects or certain types of surfaces. Alternatively, or additionally, in some embodiments, the locations of the one or more decorative objects can be determined using a suitably trained generative AI model, such as one of generative AI models 140.

In some embodiments, the locations of the one or more decorative objects can be described using relative positioning rather than absolute positioning. For example, a bouquet object can be positioned above a table object, rather than at an absolute position within designed environment 200 that corresponds to a location above the absolute position of the table object within designed environment 200. In such embodiments, the specific instance of the decorative object transient primitive can be more readily applied to other designed environments 200 besides the current designed environment 200 of interest.

In another example, in some embodiments, rendering engine 200 can apply the transient primitive “artificial lighting” to designed environment 200. In such embodiments, the effects of such artificial lighting can be based on existing interior lighting sources 205 and/or on additional interior lighting sources. In some embodiments, the number and brightness of additional interior lighting sources is determined based on a user input 102 to UI 110 (such as a slider setting or other weighting indicator). In such embodiments, each additional interior light source can be associated with a set of parameters that facilitate the implementation thereof within designed environment 200. Examples of such interior light source parameters include, without limitation, an identifier of a nearby existing object, a placement relative to the existing object (e.g., “above,” “below,” “to the side”), a color value of the additional interior light source, an intensity level of the additional interior light source, an attenuation value of the interior light source, and the like. When applied to designed environment 200, the existing interior lighting sources 205 and/or any additional interior lighting sources are positioned within designed environment 200 and rendered with illumination indicated by corresponding interior light source parameters that are based on visual content extracted from inspirational images, videos, and/or screen shots. For example, one of generative AI models 140 in FIG. 1 can be employed to determine such interior light source parameters.

In another example, in some embodiments, rendering engine 200 can apply the transient primitive “temperature” to designed environment 200. Temperature can contribute to the transient atmosphere of a particular environment, but is experienced through the sense of touch in a physical space. Therefore, temperature is a transient primitive that cannot be presented visually or aurally by UI 110. Instead, in embodiments in which the transient primitive temperature is selected to contribute to a transient atmosphere, a temperature indicator 210 is included in the rendered view of designed environment 200 to represent an ambient temperature associated with designed environment.

In another example, in some embodiments, rendering engine 200 can apply the transient primitive “weather” to designed environment 200. In such embodiments, the effects of weather can be dynamically rendered based on a set of different weather types. For example, in some embodiments, weather types that can contribute to a transient atmosphere include clear, rain, lighting, snow, and cloud/fog, among others. In some embodiments, the clear weather type includes the rendering of no particles in any visible sky included in the rendered view of designed environment 200. Alternatively, or additionally, in some embodiments, the clear weather type includes a maximum intensity of exterior light, which can be a function of the time of day transient primitive. In some embodiments, the rain weather type includes one or more effects that can be rendered in outside spaces and/or viewed through windows 202, such as animated precipitation, puddle formation on surfaces visible outside windows 202, and animated splashes in puddles. Alternatively, or additionally, in some embodiments, the rain weather type can further indicate certain contributions to ambient sound, such as the sound of rainfall or the sound of water rushing through gutters and/or downspouts. In such embodiments, parameters for factors such as size of animated drops, frequency of animated drops, volume of sound effects, and the like can be employed to modulate the rain weather type. In some embodiments, the lightning weather type includes lightning flashes that are emulated by rendering a bright white directional light that points at the scene. In such embodiments, parameters for factors such as intensity and frequency of the emulated lightning flashes can be employed to modulate the lightning weather type. In some embodiments, the snow weather type includes one or more effects that can be rendered in outside spaces and/or viewed through windows 202, such as animated precipitation of white particles, accumulation of snow on surfaces visible outside windows 202, and the like. In some embodiments, the cloud/fog weather type includes one or more effects that can be rendered in outside spaces and/or viewed through windows 202, such as animated clouds of random sizes and positions visible outside windows 202. In such embodiments, intensity parameters control the count and/or position of clouds.

In another example, in some embodiments, rendering engine 200 can apply the transient primitive “color” to designed environment 200. In such embodiments, when applied to designed environment 200, certain surfaces of designed environment 200 are rendered with a particular color that is extracted from an inspirational image, video, and/or screen shot. For example, in some embodiments, some or all interior surfaces 201, floor 203, and/or ceiling 204 can be rendered with the extracted color. Alternatively, or additionally, in some embodiments, the other structural elements can be rendered with the extracted color, such as external surfaces of designed environment 200, outdoor structures or sculptures associated with designed environment 200, and the like. In some embodiments, an intensity parameter controls the saturation of the particular color that is applied to designed environment 200. In some embodiments, one of generative AI models 140 in FIG. 1 can be employed to determine the particular color and an associated intensity parameter based on one or more inspirational images, videos, and/or screen shots.

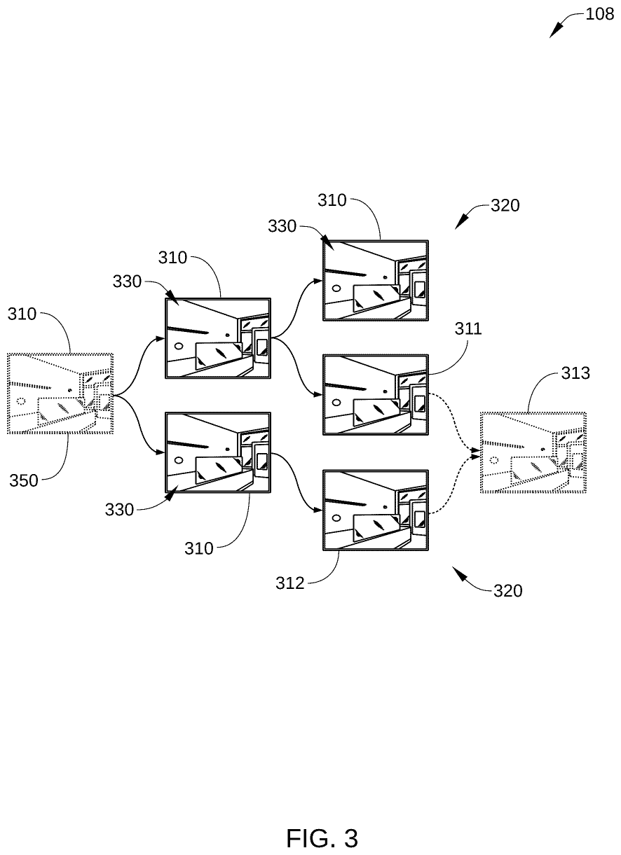

Returning to FIG. 1, visualization library 130 provides a user of transient atmosphere generation system 100 with access to a visual record of previously synthesized vibescapes for a given designed environment. The visual record is referred to herein as a history node graph, such as history node graph 108. Visualization library 130 facilitates synthesis of new vibescapes by the user by presenting chains of iteratively generated vibescapes to the user via a history node graph 108. In some embodiments, each node of history node graph 108 corresponds to a different vibescape generated by the user for a particular designed environment, where each vibescape is a combination of the particular designed environment when rendered with a different transient atmosphere. One embodiment of history node graph 108 is described below in conjunction with FIG. 3.

FIG. 3 is an illustration of a history node graph 108, according to various embodiments. History node graph 108 records results of the creative process of generating a suitable transient atmosphere for a particular designed environment at an abstract level. As noted previously, creative design can be a nonlinear process in which trial and error of new design concepts might be attempted or earlier design attempts might be combined to synthesize a new design concept. History node graph 108 enables a user of transient atmosphere generation system 100 to visually track previously generated vibescapes and the history of how each such vibescape was developed. For example, in the embodiment illustrated in FIG. 3, history node graph 108 includes a plurality of nodes 310 that are arranged in one or more branches 320 as shown. In some embodiments, history node graph 108 also includes a starting node 350 that corresponds to a blank 3D model of the particular designed environment, where no transient atmosphere has been applied to the designed environment.

Each node 310 corresponds to a different vibescape that a user has generated for the designed environment of interest. Each vibescape is formed by modifying the designed environment of interest with a particular transient atmosphere. Thus, each node 310 represents a modified version of the 3D model of the designed environment of interest. In the embodiment illustrated in FIG. 3, each node 310 includes an image 330 associated with that particular vibescape, such as a screenshot of a rendered view of the vibescape. Each node 310 is also associated with a set of data that corresponds to the particular transient atmosphere that forms the vibescape. Such data can be stored as a transient atmosphere 171 in database 170 of FIG. 1, and can include textual and/or numerical information, graphical information, and/or sound files associated with a particular transient atmosphere. In some embodiments, the data associated with a transient atmosphere 171 can be stored as one or more JavaScript Object Notation (JSON) files or other suitably formatted files. In some embodiments, the textual and/or numerical information can include slider settings or other value adjustments for adjusting or tuning a weight of a specific transient primitive that contributes to the particular transient atmosphere. In some embodiments, the graphical information can include 3D models and/or images of objects included in the particular transient atmosphere, images included in the transient atmosphere, wall papers or textures included in the transient atmosphere, and/or the like. In some embodiments, the sound files can include ambient sounds and/or music tracks extracted from inspirational media and/or ambient sounds and/or music tracks that are generated based on inspirational media and are included in the transient atmosphere.

Because each node can be associated with a unique set of data that corresponds to one particular transient atmosphere, the attributes of each transient atmosphere represented in history node graph 108 are highly portable. Thus, the attributes of each transient atmosphere can be combined with one or more other transient atmospheres (and/or with starting node 350) to synthesize a new transient atmosphere for the same 3D model, thereby generating a new node in history graph 108. For example, in some embodiments, history node graph 108 enables a user to graphically combine a first node 311 with a second node 312 to generate a third node 313 that includes some combination of the transient primitives of first node 311 and the transient primitives of second node 312. In such embodiments, additional user inputs 102 to UI 110 can be employed to select the settings of certain transient primitives of third node 313 by interpolating between the settings of the transient primitives of first node 311 and second node 312. For example, one or more slider settings or other value adjustments can be employed to select such interpolated values for the transient primitives of third node 313. In addition, in some embodiments, each transient atmosphere represented in history node graph 108 can be applied to a different 3D model by a user at a future time. Thus, a transient atmosphere generated by a user for one particular designed environment can subsequently be applied to a different designed environment than that represented by starting node 350.

Returning to FIG. 1, generative AI models 140 are employed by transient atmosphere generation system 100 for various AI-related tasks, including decomposition of a transient atmosphere associated with an item of inspirational content into various transient primitives and generating suggested transient primitives that can be applied to a designed environment. For example, in some embodiments, to decompose an item of inspirational content into various transient primitives, one or more of generative AI models 140 receives the item, such as an image or screenshot, analyzes the image for the transient primitives, such as time of day, ambient noise, ambient music, decorative objects, artificial lighting, temperature, weather, and color, among others. In some embodiments, the transient primitives extracted from the item of inspirational content are text-based transient primitives that are extracted using a large-language model AI model. In another example, in some embodiments, to generate one or more suggested transient primitives to be applied to a designed environment, for each text-based transient primitive extracted from inspirational material, one or more of generative AI models 140 generates or searches for a non-textual example of that transient primitive. Generally, the non-textual examples of transient primitives are the tangible instantiation of transient primitives, such as an actual color, decorative object, weather condition, lighting level, ambient sound, and the like. In some embodiments, the such tangible instantiations of transient primitives can be controlled via one or more parameter settings that are determined by the generative AI model 140 providing the suggested transient primitive. Examples of such parameter settings include intensity parameters (e.g., of color, lighting, brightness of sunlight, brightness of lightning, size of rain, etc.), frequency parameters (e.g., of clouds, lightning, decorative objects, etc.), location parameters, (of decorative objects, additional lighting sources, etc.), and the like.

In the embodiment illustrated in FIG. 1, generative AI models 140 are implemented as separate entities from transient atmosphere generation system 100. For example, one or more of generative AI models 140 can be cloud-computing-based, and therefore are built, trained, and deployed on cloud platforms. In other embodiments, one or more of generative AI models 140 can be an application-specific AI model that is included in transient atmosphere generation system 100.

### AI-Assisted Design of Transient Atmospheres

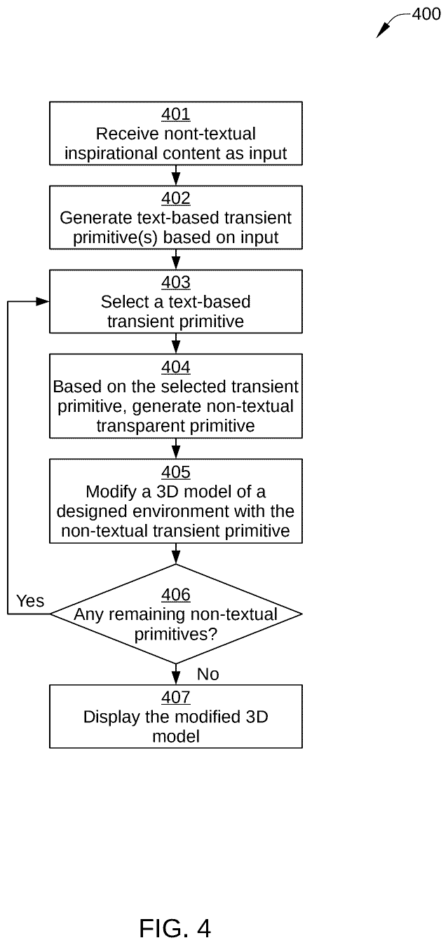

FIG. 4 sets forth a flowchart of method steps for the design of transient atmospheres for a designed environment, according to various embodiments. Although the method steps are described in conjunction with the system of FIGS. 1-3, persons skilled in the art will understand that any suitable system configured to perform the method steps, in any order, is within the scope of the embodiments.

A computer-implemented method 400 begins at step 401, where transient atmosphere generation system 100 receives non-textual inspirational material as an input, for example via UI 110. Examples of non-textual inspirational material include an image, a video or screenshot from a video, a music track, and the like.

In step 402, transient atmosphere generation system 100 generates one or more text-based transient primitives based on the input received in step 401. For example, in some embodiments, transient atmosphere generation system 100 employs a large-language model AI model, such as one of generative AI models 140, to generate the one or more text-based transient primitives. Examples of text-based transient primitives that are generated in step 402 include the names of one or more colors associated with the non-textual inspirational material, a name of an object detected within the non-textual inspirational material, a season or weather condition detected within the non-textual inspirational material, a time of day detected in the non-textual inspirational material, a word describing a sound associated with the non-textual inspirational material, and the like.

In step 403, transient atmosphere generation system 100 selects one of the text-based transient primitives generated in step 402. In step 404, transient atmosphere generation system 100 generates a non-textual transient primitive based on the text-based transient primitive selected in step 403. For example, in some embodiments, transient atmosphere generation system 100 employs a large-language model AI model, such as one of generative AI models 140, to generate the one or more text-based transient primitives. In one instance, given a name of a color as the text-based transient primitive, transient atmosphere generation system 100 employs one of generative AI models 140 to search for or generate an example of the named color. In another instance, given a name of a holiday or other theme as the text-based transient primitive, transient atmosphere generation system 100 employs one of generative AI models 140 to search for, generate, or select from a database one or more decorative objects associated with the named holiday or theme. In another instance, given a name of a sound as the text-based transient primitive, transient atmosphere generation system 100 employs one of generative AI models 140 to search for or generate ambient noise that corresponds to the named sound. In some embodiments, the generative AI model 140 determines values for one or more transient primitive parameters so that the non-textual transient primitive more closely approximates the transient primitive in the inspirational content.

In step 405, transient atmosphere generation system 100 modifies a 3D model of a designed environment of interest, such as designed environment 200, for example using rendering engine 120. In some embodiments, the 3D model is modified with a color by rendering certain surfaces of the designed environment with the color. In some embodiments, the 3D model is modified with decorative objects associated with a named holiday or theme by positioning such objects within or proximate to the designed environment. In some embodiments, the 3D model is modified with a sound by playing suitable ambient noise when displaying designed environment.

In step 406, transient atmosphere generation system 100 determines whether there are any remaining text-based primitives to be applied to the 3D model of the designed environment. If yes, computer-implemented method 400 returns to step 403; if no, computer-implemented method 400 proceeds to step 407. In step 407, transient atmosphere generation system 100 displays the modified 3D model of the designed environment, for example via UI 110.

### Exemplary Computing Device

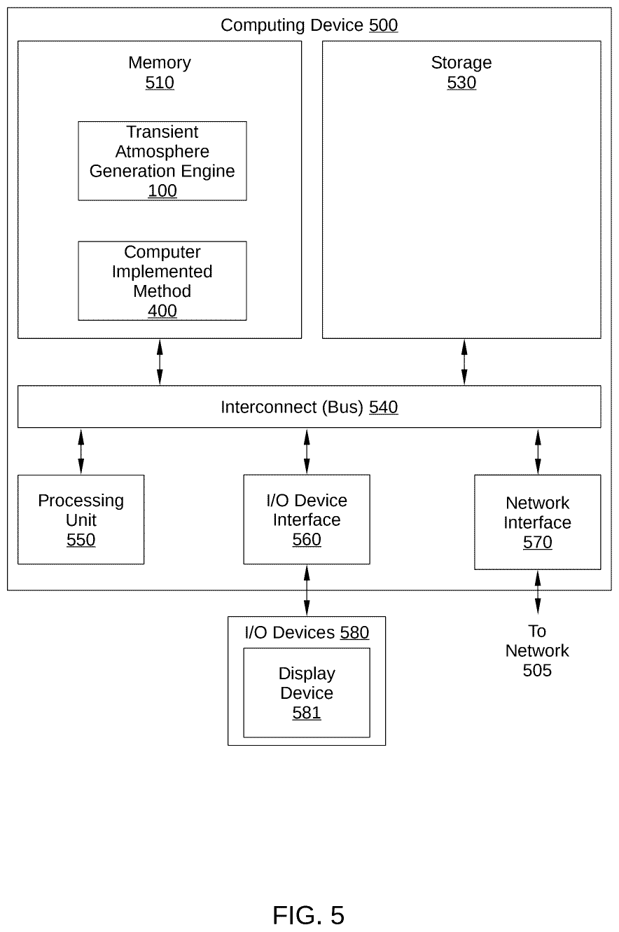

FIG. 5 is a block diagram of a computing device 500 configured to implement one or more aspects of the various embodiments. Computing device 500 may be a desktop computer, a laptop computer, a tablet computer, or any other type of computing device configured to receive input, process data, generate control signals, and display images. Computing device 500 is configured to perform operations associated with transient atmosphere generation system 100, computer-implemented method 400, and/or other suitable software applications, which can reside in a memory 510. It is noted that the computing device described herein is illustrative and that any other technically feasible configurations fall within the scope of the present disclosure.

As shown, computing device 500 includes, without limitation, an interconnect (bus) 540 that connects a processing unit 550, an input/output (I/O) device interface 560 coupled to input/output (I/O) devices 580, memory 510, a storage 530, and a network interface 570. Processing unit 550 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 550 may be any technically feasible hardware unit capable of processing data and/or executing software applications, including processes associated with transient atmosphere generation system 100 and/or computer-implemented method 400. Further, in the context of this disclosure, the computing elements shown in computing device 500 may correspond to a physical computing system (e.g., a system in a data center) or may be a virtual computing instance executing within a computing cloud.

I/O devices 580 may include devices capable of providing input, such as a keyboard, a mouse, a touch-sensitive screen, and so forth, as well as devices capable of providing output, such as a display device 581. Additionally, I/O devices 580 may include devices capable of both receiving input and providing output, such as a touchscreen, a universal serial bus (USB) port, and so forth. I/O devices 580 may be configured to receive various types of input from an end-user of computing device 500, and to also provide various types of output to the end-user of computing device 500, such as one or more graphical user interfaces (GUI), displayed digital images, and/or digital videos. In some embodiments, one or more of I/O devices 580 are configured to couple computing device 500 to a network 505.

Memory 510 may include a random access memory (RAM) module, a flash memory unit, or any other type of memory unit or combination thereof. Processing unit 550, I/O device interface 560, and network interface 570 are configured to read data from and write data to memory 510. Memory 510 includes various software programs that can be executed by processor 550 and application data associated with said software programs, including transient atmosphere generation system 100 and/or computer-implemented method 400.

In sum, the various embodiments described herein provide techniques for generating a simulated transient atmosphere for a space, structure, or environment. A transient atmosphere generation system generates transient primitives from items of inspirational content, such as images and videos, and renders the transient primitives onto a three-dimensional model of a designed environment. The transient primitives are controllable and therefore can be tailored by a designer to craft a “vibescape,” which is a simulated transient atmosphere for the designed environment. In some embodiments, the transient atmosphere generation system also provides a visual record of previously synthesized vibescapes for a given designed environment.

At least one technical advantage of the disclosed techniques relative to the prior art is that the disclosed techniques enable a designer to generate pre-construction simulations of various transient atmospheres for a particular structure, space, or environment. An additional advantage includes the ability to extract one or more transient primitives, such as colors, theme-based objects, lighting, weather effects, and ambient sound, from instances of inspirational media to contribute to a desired transient atmosphere. Furthermore, the disclosed techniques enable designers to gain access to a visual record of previously synthesized transient atmospheres, which can be used to facilitate the synthesis of new transient atmospheres. These technical advantages provide one or more technological advancements over prior art approaches.

1. In some embodiments, a computer-implemented method for generating three-dimensional (3D) models of environments comprises: receiving an input; generating, based on the input and using at least one generative artificial intelligence (AI) model, one or more transient primitives for a 3D model of an environment; applying the one or more transient primitives to the 3D model of the environment to generate a modified 3D model of the environment; and displaying the modified 3D model of the environment via at least one user interface.

2. The computer-implemented method of clause 1, wherein the input comprises a non-textual input and generating the one or more transient primitives comprises generating one or more text-based transient primitives.

3. The computer-implemented method of clauses 1 or 2, wherein generating the one or more transient primitives comprises generating one or more text-based transient primitives using a large-language model AI model.

4. The computer-implemented method of any of clauses 1-3, wherein applying the one or more transient primitives to the 3D model comprises generating a non-textual transient primitive based on a text-based transient primitive.

5. The computer-implemented method of any of clauses 1-4, wherein generating the non-textual transient primitive based on the text-based transient primitive comprises generating the non-textual transient primitive using a generative AI model.

6. The computer-implemented method of any of clauses 1-5, wherein displaying the modified 3D model of the environment comprises at least one of: rendering a surface of the 3D model with a color that is included in the one or more transient primitives; rendering a surface of the 3D model with illumination from a light source included in the one or more transient primitives; rendering at least a portion of the 3D model to include an effect of a weather type included in the one or more transient primitives; rendering at least a portion of the 3D model to include illumination based on a time of day included in the one or more transient primitives; indicating an ambient temperature value associated with the 3D model; rendering the 3D model to include at least one object that is associated with at least one transient primitive of the one or more transient primitives; playing an ambient noise that is associated with at least one transient primitive of the one or more transient primitives; and playing a selection of ambient music that is associated with at least one transient primitive of the one or more transient primitives.

7. The computer-implemented method of any of clauses 1-6, wherein applying the one or more transient primitives to the 3D model comprises: receiving a user input for modulating at least one transient primitive of the one or more transient primitives; and selecting an intensity of the at least one transient primitive.

8. The computer-implemented method of any of clauses 1-7, wherein displaying the modified 3D model comprises rendering the modified 3D model with the at least one transient primitive at the intensity.

9. The computer-implemented method of any of clauses 1-8, further comprising storing a setting value for each of the one or more transient primitives associated with the modified 3D model.

10. The computer-implemented method of any of clauses 1-9, wherein displaying the modified 3D model of the environment via at least one user interface comprises displaying one or more additional versions of the modified 3D model of the environment arranged in a history node graph associated with the 3D model.

11. The computer-implemented method of any of clauses 1-10 wherein each of the one or more additional versions of the modified 3D model comprises a design node of the history node graph associated with the 3D model.

12. The computer-implemented method of any of clauses 1-11, wherein each of the one or more additional versions of the modified 3D model corresponds to a different transient atmosphere associated with the 3D model.

13. A non-transitory computer readable medium that includes a set of instructions which, in response to execution by a processor of a computer system, cause the processor to perform the steps of: generating, based on the input and using at least one generative artificial intelligence (AI) model, one or more transient primitives for a three-dimensional (3D) model of an environment; applying the one or more transient primitives to the 3D model of the environment to generate a modified 3D model of the environment; and displaying the modified 3D model of the environment via at least one user interface.

14. The non-transitory computer readable medium of clause 13, wherein the input comprises a non-textual input and generating the one or more transient primitives comprises generating one or more text-based transient primitives.

15. The non-transitory computer readable medium of clauses 13 or 14, wherein generating the one or more transient primitives comprises generating one or more text-based transient primitives using a large-language model AI model.

16. The non-transitory computer readable medium of any of clauses 13-15, wherein applying the one or more transient primitives to the 3D model comprises generating a non-textual transient primitive based on a text-based transient primitive.

17. The non-transitory computer readable medium of any of clauses 13-16, wherein generating the non-textual transient primitive based on the text-based transient primitive comprises generating the non-textual transient primitive using a generative AI model.

18. The non-transitory computer readable medium of any of clauses 13-17, wherein applying the one or more transient primitives to the 3D model comprises: receiving a user input for modulating at least one transient primitive of the one or more transient primitives; and selecting an intensity of the at least one transient primitive.

19. The non-transitory computer readable medium of any of clauses 13-18, wherein displaying the modified 3D model comprises rendering the modified 3D model with the at least one transient primitive at the intensity.

20. In some embodiments, a system comprises: a memory that stores instructions; and a processor that is communicatively coupled to the memory and is configured to, when executing the instructions, perform the steps of: generating, based on the input and using at least one generative artificial intelligence (AI) model, one or more transient primitives for a three-dimensional (3D) model of an environment; applying the one or more transient primitives to the 3D model of the environment to generate a modified 3D model of the environment; and displaying the modified 3D model of the environment via at least one user interface.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating three-dimensional (3D) models of environments, the method comprising:
receiving an input;
generating, based on the input and using at least one generative artificial intelligence (AI) model, one or more transient primitives for a 3D model of an environment;
applying the one or more transient primitives to the 3D model of the environment to generate a modified 3D model of the environment; and
displaying the modified 3D model of the environment via at least one user interface.

2. The computer-implemented method of claim 1, wherein the input comprises a non-textual input and generating the one or more transient primitives comprises generating one or more text-based transient primitives.

3. The computer-implemented method of claim 1, wherein generating the one or more transient primitives comprises generating one or more text-based transient primitives using a large-language model AI model.

4. The computer-implemented method of claim 1, wherein applying the one or more transient primitives to the 3D model comprises generating a non-textual transient primitive based on a text-based transient primitive.

5. The computer-implemented method of claim 4, wherein generating the non-textual transient primitive based on the text-based transient primitive comprises generating the non-textual transient primitive using a generative AI model.

6. The computer-implemented method of claim 1, wherein displaying the modified 3D model of the environment comprises at least one of:
rendering a surface of the 3D model with a color that is included in the one or more transient primitives;
rendering a surface of the 3D model with illumination from a light source included in the one or more transient primitives;
rendering at least a portion of the 3D model to include an effect of a weather type included in the one or more transient primitives;
rendering at least a portion of the 3D model to include illumination based on a time of day included in the one or more transient primitives;
indicating an ambient temperature value associated with the 3D model;
rendering the 3D model to include at least one object that is associated with at least one transient primitive of the one or more transient primitives;
playing an ambient noise that is associated with at least one transient primitive of the one or more transient primitives; and
playing a selection of ambient music that is associated with at least one transient primitive of the one or more transient primitives.

7. The computer-implemented method of claim 1, wherein applying the one or more transient primitives to the 3D model comprises:
receiving a user input for modulating at least one transient primitive of the one or more transient primitives; and
selecting an intensity of the at least one transient primitive.

8. The computer-implemented method of claim 7, wherein displaying the modified 3D model comprises rendering the modified 3D model with the at least one transient primitive at the intensity.

9. The computer-implemented method of claim 1, further comprising storing a setting value for each of the one or more transient primitives associated with the modified 3D model.

10. The computer-implemented method of claim 1, wherein displaying the modified 3D model of the environment via at least one user interface comprises displaying one or more additional versions of the modified 3D model of the environment arranged in a history node graph associated with the 3D model.

11. The computer-implemented method of claim 10 wherein each of the one or more additional versions of the modified 3D model comprises a design node of the history node graph associated with the 3D model.

12. The computer-implemented method of claim 10, wherein each of the one or more additional versions of the modified 3D model corresponds to a different transient atmosphere associated with the 3D model.

13. A non-transitory computer readable medium that includes a set of instructions which, in response to execution by a processor of a computer system, cause the processor to perform the steps of:
receiving an input;
generating, based on the input and using at least one generative artificial intelligence (AI) model, one or more transient primitives for a three-dimensional (3D) model of an environment;
applying the one or more transient primitives to the 3D model of the environment to generate a modified 3D model of the environment; and
displaying the modified 3D model of the environment via at least one user interface.

14. The non-transitory computer readable medium of claim 13, wherein the input comprises a non-textual input and generating the one or more transient primitives comprises generating one or more text-based transient primitives.

15. The non-transitory computer readable medium of claim 13, wherein generating the one or more transient primitives comprises generating one or more text-based transient primitives using a large-language model AI model.

16. The non-transitory computer readable medium of claim 13, wherein applying the one or more transient primitives to the 3D model comprises generating a non-textual transient primitive based on a text-based transient primitive.

17. The non-transitory computer readable medium of claim 16, wherein generating the non-textual transient primitive based on the text-based transient primitive comprises generating the non-textual transient primitive using a generative AI model.

18. The non-transitory computer readable medium of claim 13, wherein applying the one or more transient primitives to the 3D model comprises:
receiving a user input for modulating at least one transient primitive of the one or more transient primitives; and
selecting an intensity of the at least one transient primitive.

19. The non-transitory computer readable medium of claim 18, wherein displaying the modified 3D model comprises rendering the modified 3D model with the at least one transient primitive at the intensity.

20. A system, comprising:
a memory that stores instructions; and
a processor that is communicatively coupled to the memory and is configured to, when executing the instructions, perform the steps of:
receiving an input;
generating, based on the input and using at least one generative artificial intelligence (AI) model, one or more transient primitives for a three-dimensional (3D) model of an environment;
applying the one or more transient primitives to the 3D model of the environment to generate a modified 3D model of the environment; and
displaying the modified 3D model of the environment via at least one user interface.
